(19) United States
(12) Patent Application Publication
(10) Pub. No.: US 2026/0110902 A1
(43) Pub. Date: Apr. 23, 2026

(54) DISPLAY DEVICE FOR VEHICLES

(71) Applicant: Yazaki Corporation, Tokyo (JP)

(72) Inventors: Hiroshi SANO, Shizuoka (JP); Yoshihide TAKADA, Shizuoka (JP); Yusuke SUGIURA, Shizuoka (JP)

(73) Assignee: Yazaki Corporation, Tokyo (JP)

(21) Appl. No.: 19/364,441

(22) Filed: Oct. 21, 2025

(30) Foreign Application Priority Data
Oct. 23, 2024 (JP) 2024-186486

(51) Int. Cl. G02B 27/01; G02F 1/1335

(52) U.S. Cl. CPC G02B 27/0101; G02B 27/0149; G02F 1/133528; G02F 1/133553; G02F 1/13356; G02B 2027/013; G02B 2027/0161

(57) ABSTRACT

A display device for vehicles includes a display unit that emits, as display light, a display image projected onto a windshield arranged in front of a driver via a display portion, and at least one reflection mirror that reflects the display light on an optical path of the display light from the display unit to the reflector. A liquid crystal plate that switches a polarization direction by voltage application while being sandwiched between a first polarization plate and a second polarization plate is arranged on an optical path of the display light between the reflection mirror and the display portion. The first polarization plate that transmits one of P-polarized light and S-polarized light is arranged on an upper surface of the liquid crystal plate, and the second polarization plate that transmits the other of P-polarized light and S-polarized light is arranged on a lower surface of the liquid crystal plate.

### CROSS-REFERENCE TO RELATED APPLICATIONS

The present application is based on, and claims priority from Japanese Patent Application No. 2024-186486, filed on Oct. 23, 2024, the entire contents of which are incorporated herein by reference.

### TECHNICAL FIELD

The present invention relates to a display device for vehicles.

### BACKGROUND

Some vehicles such as automobiles are equipped with a display device for vehicles, which is also referred to as a head-up display (HUD) device (see JP 2024-007661 A). The display device for vehicles includes a display (image display device) that generates and outputs display light, a reflection mirror that reflects the display light emitted from the display toward a projection target (reflector arranged in front of a vehicle occupant), and a housing that accommodates the display and the reflection mirror. The display device for vehicles is configured to allow a driver to visually recognize, as a virtual image, a display image displayed by the display by projecting the display image onto the above-mentioned projection target (reflector) via the reflection mirror or the like.

### SUMMARY OF THE INVENTION

Meanwhile, in the display device for vehicles in the related art, when the display of the display device for vehicles is turned off on a vehicle, external light including sunlight enters the inside of the display device for vehicles, and is incident on a display portion. With this, the display portion may increase in temperature and become damaged. Due to the structure of the display device for vehicles, a focal point of the reflection mirror is located on the display portion, and the external light that has entered tends to be converged onto the display portion, which also becomes a factor of the temperature increase. As a method for preventing external light from being incident on the display portion, there is a means, such as that of JP 2024-007661 A, in which the reflection mirror is driven to adjust a reflection angle of the external light. However, it is necessary to provide a space inside the display device for vehicles for driving the reflection mirror.

The present invention has been made in view of such problems in the related art. Further, an object of the present invention is to provide a display device for vehicles that prevents external light from being incident on a display portion without driving a reflection mirror.

A display device for vehicles according to an aspect of the present invention includes a display unit that emits, as display light, a display image projected onto a reflector arranged in front of a vehicle occupant via a display portion, and at least one reflection mirror that reflects the display light on an optical path of the display light from the display unit to the reflector. A liquid crystal plate that switches a polarization direction by voltage application while being sandwiched between a first polarization plate and a second polarization plate is arranged on an optical path of the display light between the reflection mirror and the display portion. The first polarization plate that transmits one of P-polarized light and S-polarized light is arranged on an upper surface of the liquid crystal plate, and the second polarization plate that transmits the other of P-polarized light and S-polarized light is arranged on a lower surface of the liquid crystal plate.

According to the present invention, it is possible to provide a display device for vehicles that prevents external light from being incident on a display portion without driving a reflection mirror.

### BRIEF DESCRIPTION OF DRAWINGS

FIG. 1 is a schematic configuration diagram illustrating an example of a vehicle equipped with a display device for vehicles according to the present embodiment.

FIG. 2 is a schematic configuration diagram illustrating an example of the display device for vehicles according to the present embodiment.

FIG. 3 is a perspective view of a display unit.

FIG. 4 is a side view of the display unit.

FIG. 5 is a schematic diagram illustrating a state in which a liquid crystal plate is sandwiched between a first polarization plate and a second polarization plate.

FIG. 6 is an enlarged view illustrating the uppermost surface of the display unit in FIG. 4.

FIG. 7 is a schematic diagram illustrating a state in which external light is transmitted when no voltage is applied to the liquid crystal panel.

FIG. 8 is a schematic diagram illustrating a state in which external light is transmitted when a voltage is applied to the liquid crystal panel.

FIG. 9 is a schematic configuration diagram illustrating an example of the display device for vehicles according to the present embodiment.

FIG. 10 is a schematic diagram illustrating a state in which external light is incident on an uppermost surface of a display unit in a display device for vehicles in the related art.

FIG. 11 is a schematic diagram illustrating a state in which external light is incident on the uppermost surface of the display unit.

FIG. 12 is a schematic diagram illustrating a state in which external light is incident on the uppermost surface of the display unit.

### DETAILED DESCRIPTION OF THE INVENTION

With reference to the drawings, a display device for vehicles according to the present embodiment is described below in detail. Note that the dimensional ratios in the drawings are exaggerated for explanatory purposes, and may differ from the actual ratios.

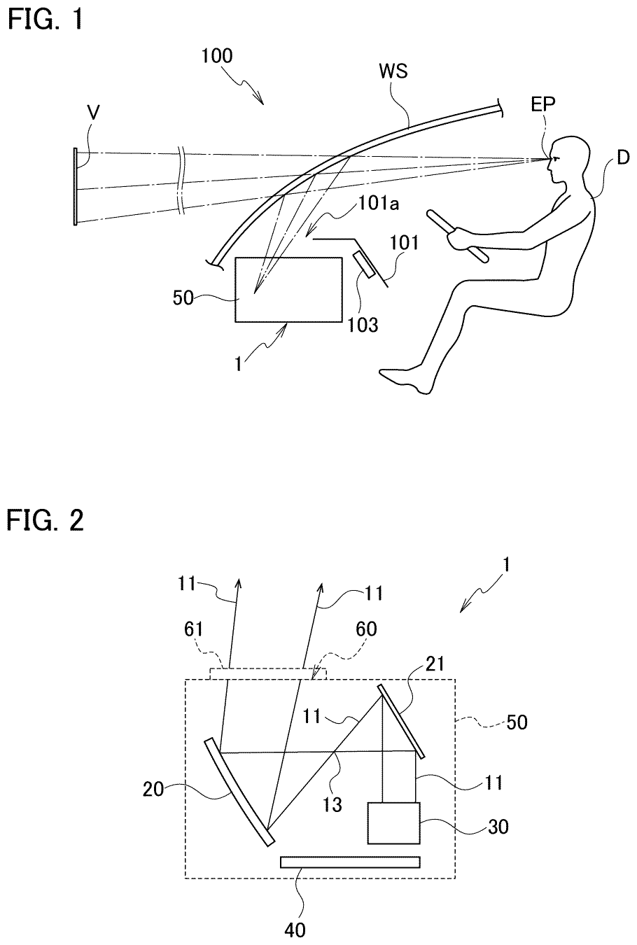

As illustrated in FIG. 1, a display device 1 for vehicles according to the present embodiment is a head-up display device that is mounted on a vehicle 100 such as an automobile. The display device 1 for vehicles is arranged inside a dashboard 101 together with a meter 103, and displays a virtual image V in front of an eye point EP of the vehicle 100. The eye point EP is a position that is predetermined as a viewpoint position of a vehicle occupant (driver D) seated in a driver's seat.

The display device 1 for vehicles is arranged inside the dashboard 101 of the vehicle 100. An upper opening portion 101a is provided on an upper surface of the dashboard 101, and the display device 1 for vehicles projects a display image onto a windshield WS via the upper opening portion 101a. The windshield WS is a reflector arranged in front of the driver D in the vehicle 100. For example, the windshield WS has semitransparency, and reflects light incident from the display device 1 for vehicles toward the eye point EP. The driver D recognizes an image reflected by the windshield WS as the virtual image V. The virtual image V is recognized by the driver D as if it exists in front of the windshield WS.

As illustrated in FIG. 2, the display device 1 for vehicles according to the present embodiment includes reflection mirrors 20 and 21, a display unit 30, a control unit 40, and a housing 50.

For example, the housing 50 is obtained by forming a synthetic resin material into a box-like shape, and has an internal space inside. The housing 50 accommodates the reflection mirrors 20 and 21, the display unit 30, and the control unit 40 in the internal space, and holds those components. The housing 50 includes an opening portion 60 that allows communication between an outside of the housing 50 and the internal space. The opening portion 60 is provided at a position on an upper wall portion of the housing 50 to face the windshield WS. Further, a cover member 61 formed of a light-transmissive synthetic resin material (for example, an acrylic resin) is provided to the upper wall portion of the housing 50 so as to close the opening portion 60. The display device 1 for vehicles emits display light 11 from the housing 50 toward the windshield WS via the opening portion 60. The display light 11 is light that is emitted from the display unit 30 and reflected by the reflection mirrors 20 and 21.

The control unit 40 is electrically connected to the display unit 30, and executes display control for a display image (virtual image V) displayed by the display device 1 for vehicles. The control unit 40 is configured by an IC chip or the like, and is driven by power obtained from a battery in the vehicle 100. Further, the control unit 40 may be electrically connected to an electronic control unit (ECU) in the vehicle 100, and may execute transmission and reception of a signal with the ECU.

The display unit 30 emits, as the display light 11, a display image projected onto the windshield WS. The display unit 30 includes a backlight housing 31, a display portion 32, a liquid crystal plate 33, a first polarization plate 34, and a second polarization plate 35.

Inside the backlight housing 31, a backlight unit (omitted in illustration) is provided. The backlight unit outputs the display light 11 of the display image, and illuminates the display portion 32 from the back surface side. The display portion 32 emits light from a display surface on the front surface side by being illuminated from the back surface side. Further, the display unit 30 emits, as the display light 11, a display image projected onto the windshield WS via the display portion 32.

The display device 1 for vehicles includes at least one of the reflection mirrors 20 and 21 on an optical path of the display light 11 from the display unit 30 to the windshield WS. The reflection mirrors 20 and 21 reflect the display light 11 emitted from the display unit 30 toward the windshield WS. As illustrated in FIG. 2, at least one of the reflection mirrors 20 and 21 may include a first mirror 20 and a second mirror 21.

The first mirror 20 is arranged at a position facing the opening portion 60 of the housing 50 and on the optical path between the opening portion 60 of the housing 50 and the second mirror 21. The first mirror 20 may include a reflection surface formed as a concave curved surface or a convex curved surface, and may be a concave mirror. The first mirror 20 totally reflects the display light 11 reflected by the second mirror 21 toward the windshield WS via the opening portion 60. A reflection layer may be formed on the reflection surface of the first mirror 20 by vapor deposition or the like.

The first mirror 20 has a function as an enlargement mirror. In other words, the first mirror 20 enlarges and reflects the display image such that the display image represented by the display light 11 after being reflected by the first mirror 20 becomes relatively larger than the display image represented by the display light 11 before being reflected by the first mirror

The second mirror 21 is arranged at a position facing the display unit 30. The second mirror 21 may include a reflection surface formed as a plane surface or a concave curved surface, and may be a plane mirror or a concave mirror. The second mirror 21 totally reflects the display light 11 emitted from the display unit 30 toward the first mirror 20 by the reflection surface. A reflection layer may be formed on the reflection surface of the second mirror 21 by vapor deposition or the like. Further, a cross optical path can be formed between the first mirror 20 and the second mirror 21 by adopting a concave mirror as the second mirror 21. In other words, the display light 11 reflected by the second mirror 21 may intersect at a cross point 13, and then may be reflected by the first mirror 20 and reach the windshield WS. When such a cross optical-path design can be incorporated into the display device 1 for vehicles, there is no need to provide a space in the optical path. Thus, as described later, in combination with the fact that there is no need to provide a space for driving the reflection mirrors 20 and 21 inside the display device 1 for vehicles in order to prevent incidence of external light 12 on the display portion 32, space saving inside the display device 1 for vehicles can be further promoted.

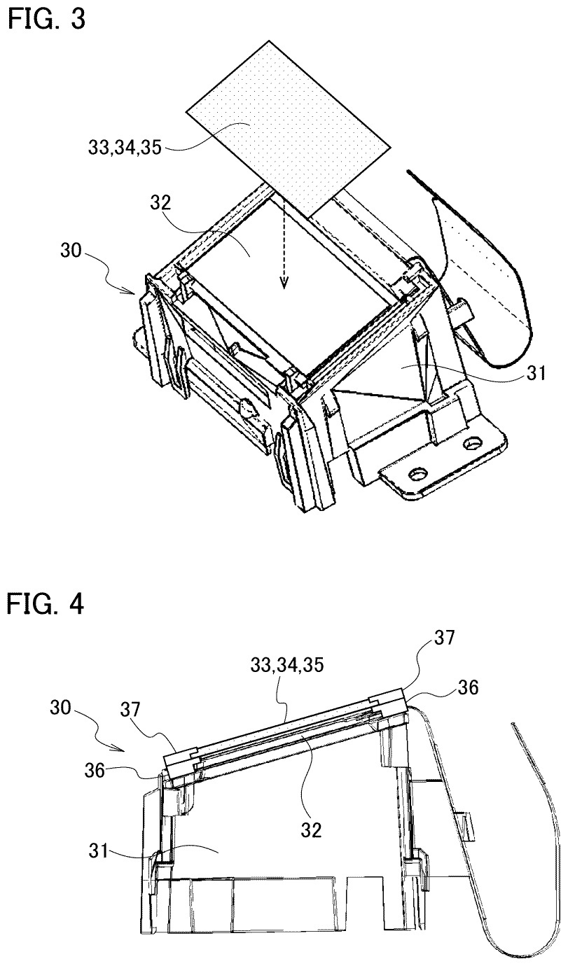

As illustrated in FIG. 2 to FIG. 6, the liquid crystal plate 33 that switches the polarization direction by voltage application while being sandwiched between the first polarization plate 34 and the second polarization plate 35 is arranged on an optical path of the display light 11 between the reflection mirrors 20 and 21 and the display portion 32.

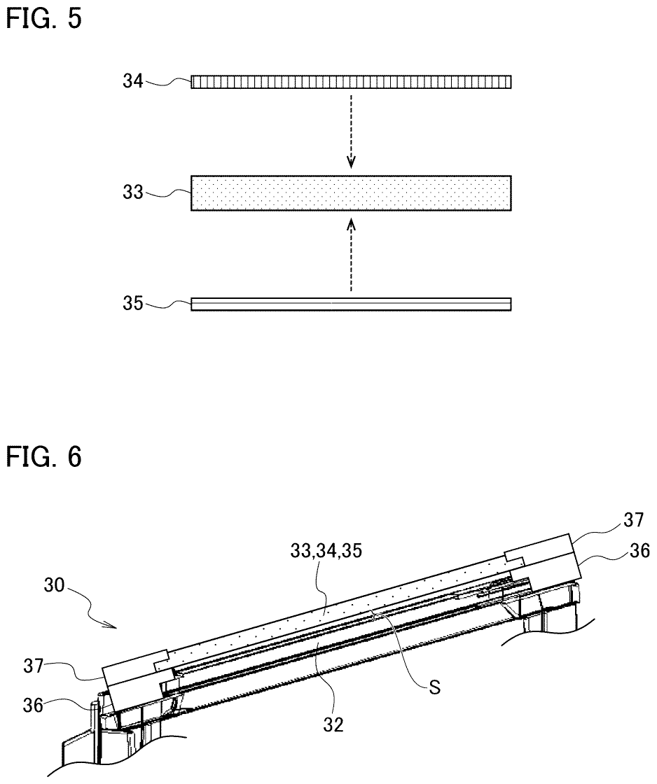

The liquid crystal plate 33 is sandwiched between the first polarization plate 34 and the second polarization plate 35. Specifically, as illustrated in FIG. 5, the first polarization plate 34 that transmits one of P-polarized light and S-polarized light is arranged on an upper surface of the liquid crystal plate 33, and the second polarization plate 35 that transmits the other of P-polarized light and S-polarized light is arranged on a lower surface of the liquid crystal plate 33. The liquid crystal plate 33 sandwiched between the first polarization plate 34 and the second polarization plate 35 may be configured to be supported above the display portion 32 by using an attachment member 37 so that the second polarization plate 35, the liquid crystal plate 33, and the first polarization plate 34 are stacked in the stated order from the bottom. Further, the liquid crystal plate 33 sandwiched between the first polarization plate 34 and the second polarization plate 35 may be configured to be supported by the housing 50 so as to obtain the above-mentioned state.

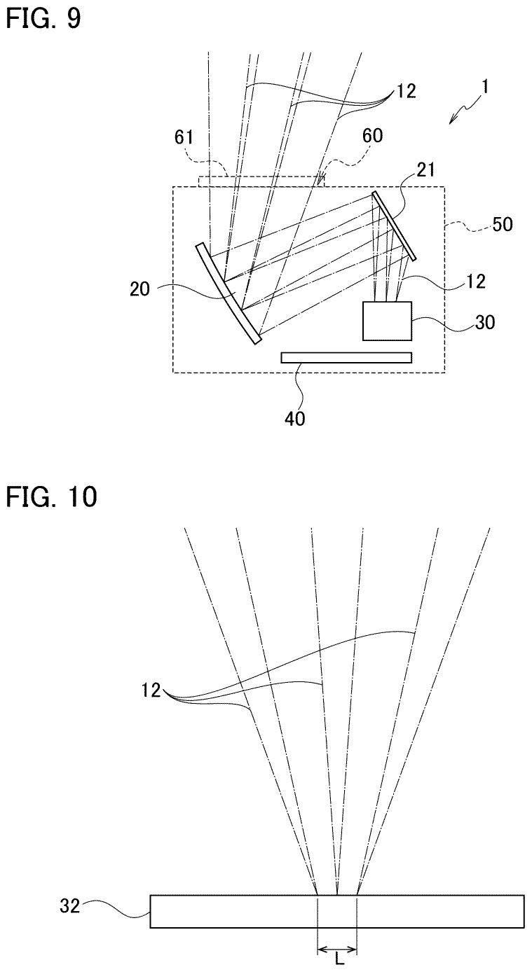

In the display device 1 for vehicles, the external light 12 such as sunlight may be incident on the inside of the housing 50 from the opening portion 60 of the housing 50. As illustrated in FIG. 9, the external light 12 is incident on the housing 50 via the opening portion 60, is converged by being reflected by the first mirror 20 functioning as an enlargement mirror, and is directed toward the display unit 30 via the second mirror 21. In other words, the liquid crystal plate 33 sandwiched between the first polarization plate 34 and the second polarization plate 35 is arranged not only on the optical path of the display light 11 but also on the optical path of the external light 12.

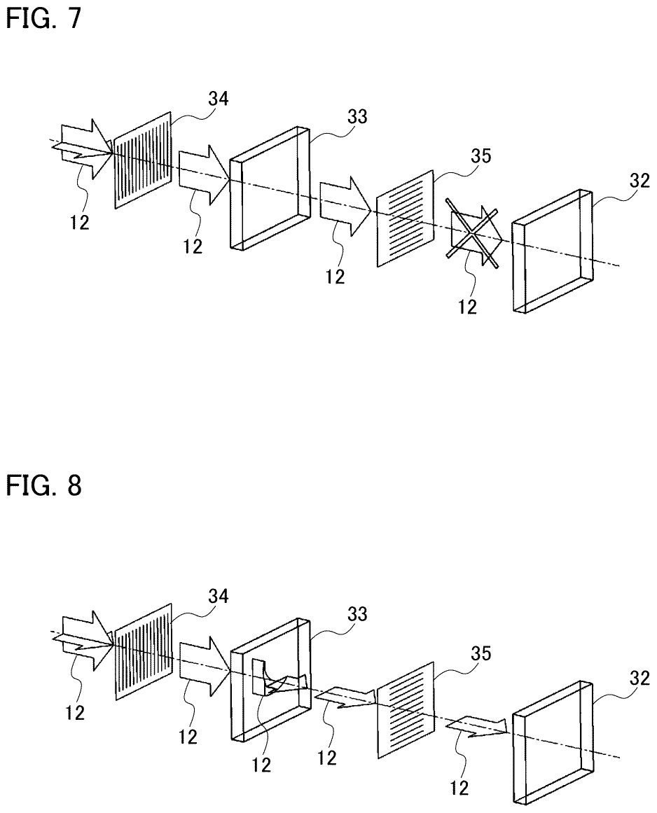

As described above, the liquid crystal plate 33 can switch the polarization direction by voltage application. FIG. 7 and FIG. 8 illustrate a comparison of how the external light 12 is transmitted through the liquid crystal plate 33 sandwiched between the first polarization plate 34 and the second polarization plate 35, between a case in which no voltage is applied to the liquid crystal plate 33 and a case in which a voltage is applied thereto. Herein, for description, one polarized light is set as P-polarized light, and the first polarization plate 34 is assumed to transmit P-polarized light. The other polarized light is set as S-polarized light, and the second polarization plate 35 is assumed to transmit S-polarized light. However, settings of P-polarized light and S-polarized light may be reversed.

As illustrated in FIG. 7, when no voltage is applied to the liquid crystal plate 33, first, the external light 12 is polarized in the vertical direction by being transmitted through the first polarization plate 34 where the polarization direction is the vertical direction. Then, the external light 12 is transmitted through the liquid crystal plate 33, but cannot be transmitted through the second polarization plate 35 where the polarization direction is the horizontal direction, which is different from the polarization direction of the external light 12. Thus, optical components of the external light 12 in both the directions, namely, P-polarized light and S-polarized light are blocked by the first polarization plate 34 and the second polarization plate 35, and hence the external light 12 does not reach the display portion 32. Note that, similarly to the external light 12, optical components of the display light 11, which is emitted via the display portion 32, in both the directions, namely, P-polarized light and S-polarized light are also blocked by the first polarization plate 34 and the second polarization plate 35, and hence cannot be transmitted.

In contrast, as illustrated in FIG. 8, when a voltage is applied to the liquid crystal plate 33, first, the external light 12 is polarized in the vertical direction by being transmitted through the first polarization plate 34 where the polarization direction is the vertical direction. Then, in the liquid crystal plate 33, the polarization direction is switched by voltage application so as to match a direction of the other light component, namely the horizontal direction. Thus, external light 12 can be transmitted through the second polarization plate 35 where the polarization direction is the horizontal direction, which matches with the polarization direction of the external light 12. Consequently, the external light 12 reaches the display portion 32. Note that, similarly to the external light 12, regarding the display light 11 emitted via the display portion 32, a light component in the polarization direction being any one of P-polarized light and S-polarized light can also be transmitted.

Thus, in association with turning off the display of the display device 1 for vehicles, a state in which no voltage is applied to the liquid crystal plate 33 is established. With this, the external light 12 does not reach the display portion 32, and hence incidence of the external light 12 on the display portion 32 can be prevented. In the related art, in order to prevent incidence of the external light 12 on the display portion 32, a means for driving the reflection mirrors 20 and 21, in particular, the first mirror 20 and for adjusting a reflection angle of the external light 12 is used. In the display device 1 for vehicles according to the present embodiment, incidence of the external light 12 on the display portion 32 can be prevented without driving the reflection mirrors 20 and 21. Further, there is no need to provide a space for driving the reflection mirrors 20 and 21 inside the display device 1 for vehicles, and hence space saving inside the display device 1 for vehicles can be expected.

As described above, in association with turning off the display of the display device 1 for vehicles, a state in which no voltage is applied to the liquid crystal plate 33 is established. With this, similarly to the external light 12, the display light 11 is also prevented from being transmitted. Thus, an on/off switching of the display of the display device 1 for vehicles is performed in association with an on/off switching of a vehicle power supply, and hence transmission of the display light 11 can be controlled.

With regard to the liquid crystal plate 33 sandwiched between the first polarization plate 34 and the second polarization plate 35, the second polarization plate 35 is arranged at the position closest to the display portion 32, and a gap S is preferably provided on an optical path of the display light 11 between the second polarization plate 35 and the display portion 32. Similarly to the liquid crystal plate 33, the display portion 32 is a constituent component that is operated by voltage application. Thus, when the second polarization plate 35 and the display portion 32 are arranged to overlap with each other, not only concentrated heat generated by external light 12 but also heat generated by voltage application is added, and there arises a possibility that the temperature of the display portion 32 increases. Thus, in the display device 1 for vehicles, when the gap S is provided between the second polarization plate 35 and the display portion 32, the space is formed above the display portion 32. Consequently, even when the display of the display device 1 for vehicles is turned on, an amount of heat accumulated in the display portion 32 can be reduced.

In order to provide the gap S between the second polarization plate 35 and the display portion 32, a buffer member 36 is preferably arranged in the periphery of the optical path of the display light 11 between the second polarization plate 35 and the display portion 32. The shape and the material of the buffer member 36 are not particularly limited, and the buffer member 36 may be a member such as a bezel and a packing placed on a peripheral edge portion of the display portion 32. Further, the buffer member 36 may be a member to be placed on the peripheral edge portion of the display portion 32 in the process of stacking and assembling the second polarization plate 35, the liquid crystal plate 33, and the first polarization plate 34 in the stated order above the display portion 32. As illustrated in FIG. 6, the buffer member 36 is arranged at the peripheral edge portion of the display portion 32, and the second polarization plate 35, the liquid crystal plate 33, and the first polarization plate 34 may be supported above the display portion 32 via the gap S by additionally using the attachment member 37 while being stacked in the stated order from the bottom. Further, when a member having heat dissipation properties is used as the buffer member 36, an effect of preventing a temperature increase of the display portion 32 can further be improved.

Further, as the buffer member 36, an additional structure may be provided to the display unit 30 so that a spacer formed in a frame-like shape is provided. Further, the buffer member 36 may be a structure additionally provided to the frame of the display unit 30. In other words, the buffer member 36 may be a structure that is additionally provided for a spacer purpose when the display unit 30 is manufactured in a factory or the like, or may be a structure previously provided in the process of stacking and assembling the second polarization plate 35, the liquid crystal plate 33, and the first polarization plate 34 in the stated order above the display portion 32.

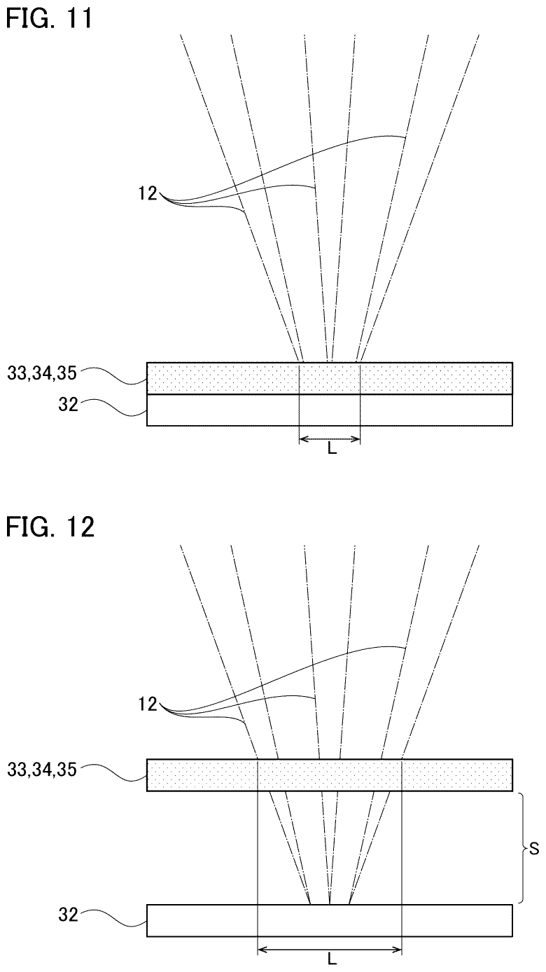

As illustrated in FIG. 9, the external light 12 is converged by being reflected by the first mirror 20, and is directed toward the display unit 30 via the second mirror 21. In a case in which only the display portion 32 is arranged on the uppermost surface as in the related-art display device, a focal point of a concave mirror is located on the display portion 32, and hence the external light 12 is converged onto the display portion 32 as illustrated in FIG. 10. In the display device 1 for vehicles according to the present embodiment, the liquid crystal plate 33 sandwiched between the first polarization plate 34 and the second polarization plate 35 is arranged above the display portion 32, and hence an area L of the external light 12 incident on the uppermost surface of the display unit 30 is widened, as illustrated in FIG. 11. Thus, as compared with a case in which only the display portion 32 is arranged, concentrated heat applied to the display portion 32 can be reduced. When the gap S is provided above the display portion 32, and the liquid crystal plate 33 sandwiched between the first polarization plate 34 and the second polarization plate 35 is arranged, the area L of the external light 12 incident on the uppermost surface of the display unit 30 is further widened, as illustrated in FIG. 12, and concentrated heat applied to the display portion 32 can further be reduced. As described above, in the display device 1 for vehicles, the gap S is provided between the second polarization plate 35 and the display portion 32. Thus, even when the display of the display device 1 for vehicles is turned on, concentrated heat applied to the display portion 32 by the external light 12 can be reduced, and a temperature increase can be prevented.

As described above, the display device 1 for vehicles according to an aspect of the present embodiment includes the display unit 30 that emits, as the display light 11, the display image projected onto the reflector (windshield WS) arranged in front of the vehicle occupant (driver D) via the display portion 32. Further, the display device 1 for vehicles includes at least one of the reflection mirrors 20 and 21 that reflects the display light 11 on the optical path of the display light 11 from the display unit 30 to the reflector. The liquid crystal plate 33 that switches the polarization direction by voltage application while being sandwiched between the first polarization plate 34 and the second polarization plate 35 is arranged on the optical path of the display light 11 between the reflection mirrors 20 and 21 and the display portion 32. The first polarization plate 34 that transmits one of P-polarized light and S-polarized light is arranged on the upper surface of the liquid crystal plate 33, and the second polarization plate 35 that transmits the other of P-polarized light and S-polarized light is arranged on the lower surface of the liquid crystal plate 33. The liquid crystal plate 33 sandwiched between the first polarization plate 34 and the second polarization plate 35 is arranged above the display portion 32. With this, when the display of the display device 1 for vehicles is turned off, it is possible to prevent external light from being incident on the display portion without driving the reflection mirrors 20 and 21.

Further, there is no need to provide a space inside the display device 1 for vehicles for driving the reflection mirrors 20 and 21, and hence space saving inside the display device 1 for vehicles can be expected. Moreover, when a cross optical-path design can be incorporated into the display device 1 for vehicles, there is no need to provide a space in the optical path, and hence space saving inside the display device 1 for vehicles can be further promoted.

Further, a time for driving the reflection mirrors 20 and 21 is not required when an on/off switching of the display of the display device 1 for vehicles is performed in association with an on/off switching of a vehicle power supply, and hence an operation time can be shortened.

Moreover, in the display device 1 for vehicles, the gap S is provided on the optical path of the display light 11 between the second polarization plate 35 and the display portion 32. With this, even when the display of the display device 1 for vehicles is turned on, an amount of heat accumulated in the display portion 32 can be reduced, and a temperature increase can be prevented. Further, the area L of external light 12 incident on the uppermost surface of the display unit 30 is widened. With this, concentrated heat is reduced, and an amount of heat accumulated in the display portion 32 can further be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A display device for vehicles comprising:
a display unit that emits, as display light, a display image projected onto a reflector arranged in front of a vehicle occupant via a display portion; and
at least one reflection mirror that reflects the display light on an optical path of the display light from the display unit to the reflector, wherein
a liquid crystal plate that switches a polarization direction by voltage application while being sandwiched between a first polarization plate and a second polarization plate is arranged on an optical path of the display light between the reflection mirror and the display portion,
the first polarization plate that transmits one of P-polarized light and S-polarized light is arranged on an upper surface of the liquid crystal plate, and
the second polarization plate that transmits the other of P-polarized light and S-polarized light is arranged on a lower surface of the liquid crystal plate.

2. The display device for vehicles according to claim 1, wherein
the at least one reflection mirror includes a first mirror and a second mirror,
the first mirror is a concave mirror, and
the second mirror is a plane mirror or a concave mirror.

3. The display device for vehicles according to claim 1, wherein
a gap is provided on an optical path of the display light between the second polarization plate and the display portion.

4. The display device for vehicles according to claim 3, wherein
a buffer member is arranged in the periphery of the optical path of the display light between the second polarization plate and the display portion.
